(19) United States
(12) Patent Application Publication
(10) Pub. No.: US 2006/0132839 A1
(43) Pub. Date: Jun. 22, 2006

(54) Data frame having database access information

(75) Inventors: Steven C. Sitter, Fairport, NY (US); John R. Fredlund, Rochester, NY (US); David A. Hodder, Spencerport, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/022,154

(22) Filed: Dec. 22, 2004

(51) Int. Cl. G06F 3/12

(52) U.S. Cl. 358/1.15

(57) ABSTRACT

In a photofinishing method an image unit is received. The image unit has a plurality of image frames including a data frame and a plurality of non-data frames. The data frame bears access information for a database. The image frames are printed. The access information is readable on a print of the data frame. The image frames are transmitted to the database. In the database, the data frame is extracted and the access information is read. The access information on the print of the data frame can be used to access the non-data frames in the database for retrieval or to obtain additional prints or other output.

### CROSS REFERENCE TO RELATED APPLICATIONS

Reference is made to commonly assigned, co-pending U.S. patent application Ser. No.______, [Attorney Docket No. 87052], entitled: CONTROLLING PHOTOFINISHING USING DATA FRAME DESIGNATED PHOTOFINISHING SUBCHANNELS, filed Dec. 22, 2004, in the names of John R. Fredlund, Steven C. Sitter, William G. Peters, David C. Smart, which is hereby incorporated by reference herein.

Reference is made to commonly assigned, co-pending U.S. patent application Ser. No.______, [Attorney Docket No. 89280], entitled: CONTROLLING PHOTOFINISHING USING RANKED DATA FRAMES, filed Dec. 22, 2004, in the names of Steven Sitter, John Fredlund; which is hereby incorporated by reference herein.

### FIELD OF THE INVENTION

The invention relates generally to the field of photofinishing, and in particular to customized or specialized photofinishing. More specifically, the invention relates to a methods and systems, in which a film unit or other image unit includes a data frame that includes a URL or other database access information.

### BACKGROUND OF THE INVENTION

In recent years, it has become apparent that a great many people prefer their picture taking to produce prints as final images. On the other hand many people like having further additional options for other image fulfillment. This can involve storing images in a database and allowing users to access their images in the database to order image fulfillment. It is known to combine these two forms of output.

U.S. Pat. No. 6,373,551 to Manico et al., discloses a system in which photographic film is sold with a pre-paid mailer having a tear off receipt imprinted with information for accessing a database. A code number on the film is used to generate a corresponding database entry during photofinishing. This system requires a specialized mailer and photofinishing equipment capable of reading and generating appropriate information from the code number.

U.S. Pat. No. 6,367,991, to Garfinkle et al. and U.S. Pat. No. 6,674,923, to Shih et al., disclose systems in which an index print having database access information is returned with prints. The database access information is provided on an empty portion of the index print or as an attachment/enclosure. A shortcoming of these systems is that the photofinishing equipment must be capable of providing a special index print.

U.S. Pat. No. 5,799,219 to Moghadam et al., discloses a system in which digital information including database access information is recorded on the magnetic layer of a filmstrip, before photofinishing. This approach requires use of film having a magnetic layer and equipment capable of writing and reading the magnetic layer.

U.S. Pat. No. 5,587,752, to Petruchik, discloses a film cartridge that uses a data frame, that is, an image frame having subchannel information, positioned near the trailer end of the filmstrip to designate a set of prerecorded images for compositing. This method uses a special camera to place marks on the film. These marks make selections from the prerecorded image set identified by the data frame. This method requires a specialized camera, but the data frame can be scanned by digital photofinishing equipment using the same scanner that is used for scanning other film frames.

U.S. Pat. No. 6,429,924, to Milch, is similar to Petruchik, but has a data frame in the form of an image of a pattern at each end of the filmstrip. The pattern, when scanned during photofinishing, indicates that metadata for individual frames is present within the portion of the filmstrip bearing the sequence of images.

U.S. Pat. No. 6,628,895, to Fredlund et al., discloses a method for capturing a single data frame on a film unit within a camera by photographing a card bearing information for the data frame.

It would thus be desirable to provide systems and methods, in which database access information can be provided to a user with little extra equipment or effort.

### SUMMARY OF THE INVENTION

The invention is defined by the claims. The invention, in broader aspects, provides a photofinishing method, in which an image unit is received. The image unit has a plurality of image frames including a data frame and a plurality of non-data frames. The data frame bears access information for a database. The image frames are printed. The access information is readable on a print of the data frame. The image frames are transmitted to the database. In the database, the data frame is extracted and the access information is read. The access information on the print of the data frame can be used to access the non-data frames in the database for retrieval or to obtain additional prints or other output.

It is an advantageous effect of the invention that improved systems and methods are provided, in which database access information can be provided to a user with little extra equipment or effort.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a diagrammatical view of an embodiment of the system.

FIG. 2 is a flow chart of an embodiment of the method.

FIG. 3 is a diagrammatical view of another embodiment of the system.

### DETAILED DESCRIPTION OF THE INVENTION

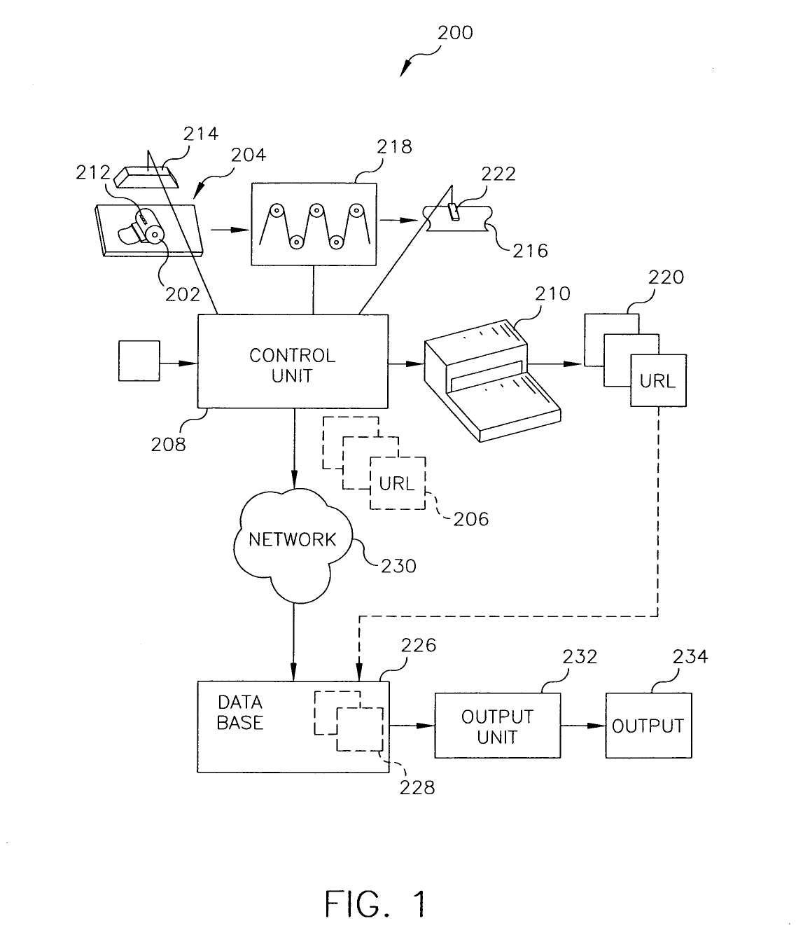

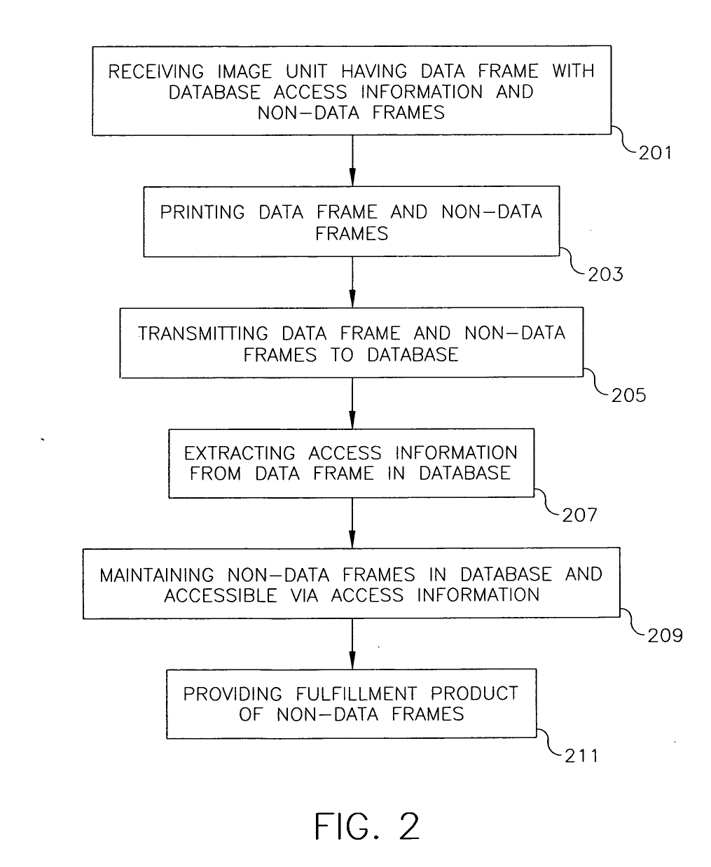

Referring to FIGS. 1-2, in the methods and system 200, an image unit 202 is received (201) at an entry station 204. The image unit 202 has printable image frames including a data frame and one or more non-data frames. The data frame includes database access information in the form of readable indicia. A bitstream 206 of the image frames is formed and sent to a controller or control unit 208. The image frames are sent with instructions to an output device 210 (illustrated as a printer) and an output 220, such as a series of prints, is provided (203). One of the prints is the data frame, which has readable access information for the database (indicated in FIG. 2 by “URL”).

If the image unit 202 is a film cartridge, channel information 212, such as a DX code, is detected on a photographic film image unit 202 using a detector 214. The channel information is sent to the controller or control unit 208. The filmstrip 216 of the film unit 202 is chemically processed in a development unit 218, in accordance with the channel information. The developed filmstrip 216 is scanned with a scanner 222 and the bitstream 206 of images is sent to the controller 208, which provides fulfillment instructions for the image frames. The system 200 has a reader 224, which can be used with a digital image unit (not illustrated) to produce like results.

The control unit 208 also transmits (205) the image frames as a digital output 206 to a database 226. Transmission can be direct or via a local or remote network 230. The data frame is extracted (207) and the access information is read and the non-data frames 228 are stored in the database 226. The data frame does not need to be extracted and read until the image frames are submitted to the database. The non-data frames are maintained (209) available for retrieval and/or fulfillment (211) via an output unit 232 that provides an output 234. Access to the non-data frames and/or provision of a fulfillment product is provided upon submission of the access information to the database.

The system has two branches, a first that provides photofinishing and output without reading the access information on the data frame and a second branch having a database that extracts the data frame and reads the access information. The first branch can be any form of conventional photofinishing, subject only to the limitation that the image frames, including the data frame, are transmitted to the second branch. Transmission can be automatic for all of the image frames of every image unit processed by the first branch. Alternatively, the first branch can detect the presence of a data frame, by means of an external indicator (not shown) on the image unit or by detecting the presence of the data frame in the image unit. Metadata or a separate digital file can be provided to signal the presence of the data frame. The control unit can also detect the presence of a data frame by use of a shape recognition algorithm, as discussed below.

The system provides the advantage that the database access information is provided to the user in a manner that greatly reduces the risk of loss of that information or dissociation from the printed images or other output to which it relates. The database access information is provided on a final image that is treated like the rest of the final images. With printed images, the database access information appears in one of the prints and/or on the same index print. This result does not require any change in the photofinishing equipment of the first branch, other than some means for transmitting the image frames, in digital form, to the database. Since the database can be remotely accessed and shared by many sets of first branch photofinishing equipment, this reduces the costs of implementation.

The photofinishing unit of the first branch outputs printed images or other fulfillment of the data frame and the non-data frames. The data frame includes the access information for the database. The access information includes an identification of the database and information, such as an identification code and password, necessary to access a particular location within the database.

The data frame and the non-data frames are, preferably, all printed the same way. For example, data frame and non-data frames can all be provided as separate 4×6 prints on photographic paper or thermal transfer paper or the like. It is preferred that printed images of the data frame and non-data frames be provided on a common index print. The index print can be provided in addition to or instead of separate larger prints. As an option, the printing of the data frame can be allowed for the index print, but suppressed in the printing of the larger prints. The provision of the data frame as one of the images on the index print allows easy use, since the database access information is directly associated with the images to which it refers. It is preferred that the index print is a single page or sheet, but multiple sheets can be provided, if necessary to accommodate a large number of non-data images. The index print is not limited to a piece of paper and can be printed on storage media, such as a CD or DVD. In that case, the media can include the non-data images and, optionally, the access information, as digital files. The access information is also present, in visible form, in the printed image of the data frame. The data frame can be the same size as other printed images on the index print or can be scaled differently to allow easier reading (human or by scanning using a machine) of the access information. This treatment of the data frame in a different manner than the other frames is dependent upon recognition of the existence of the data frame in the image frames photofinished in the first branch of the system. That recognition of the presence of the data frame and differential treatment in provision of final images are optional.

The digital output is sent to the database for storage. The digital output includes the data frame and the non-data frames. The database extracts the access information from the data frame and configures storage of the non-data frames in the database so as to be accessible using the access information. The database includes memory and computing hardware and software necessary to carry out this function. For example, the database can include one or more programmed microprocessors and communications equipment necessary to interface with one or more networks. For example, access information on the data frame can be text indicating a URL and a password. In that case, the database is a network server connected to the Internet, and the respective non-data frames are accessible by use of the URL as an address for a Web browser, followed by submission of the password when requested by the database.

The method and system relate to light images of scenes that have been captured in an image unit as image frames. The term “image unit” is used herein to refer to both film units and memory units. The film unit has a piece of film, such as a filmstrip, and, for some types of film unit, has a holder for the filmstrip. A memory unit includes computer readable digital storage media that provides digital memory for an electronic camera or other capture device. The form of the memory is not critical. For example, the memory can be optical, such as an optical CD or DVD, electronic such as a digital memory card; or magnetic such as magnetic tape.

The image unit has a plurality of frames. The term “frame” is used herein to refer to space within the image unit, which stores or is capable of storing a captured image. With photographic film, a frame is a segment of film. With digital memory, a frame is a physical and/or logical subunit of the memory unit. The term “image frame” is used herein to refer to image information that is or has been stored within a frame. The image information corresponds to a captured light image, is analog, in the case of photographic film, and can be in the form of a latent image (before chemical processing) or a visible image (following chemical processing). The image information is digital, in the case of a captured digital image stored as a digital file in a frame of a memory unit.

The image unit is generally discussed herein in terms of the same media being used for both capture and storage of archival image information. It should be understood that stored images may, in some cases, be transferred to a replacement medium one or more times. For example, an image unit can start out with the features of a one-time use photographic film camera. After film exposure, the camera body is removed; the filmstrip is removed from its canister and developed, and the film is scanned and the resulting digital images are stored in memory and digitally processed. Image frames captured with a digital camera are transferred from one type of digital memory to another, during photofinishing. The image frames of an image unit remain associated with each other at least through photofinishing.

The stored image frames are generally treated herein as being realistic images of the subject photographed and having the same, unchanging information content as the original light image. It will be understood that this is a simplification provided as a matter of convenience for explanatory purposes and that captured and stored image frames will differ from initially captured images in a manner well known to those of skill in the art. For example, the image frames must differ from the original light image, since the captured and stored image frames are subject to the limitations of the imaging system and the media. Film image frames are subject to limitations such as grain size. Digital image frames are necessarily pixellated and commonly have color values partially extrapolated from neighboring pixels. Both types of image frames may also be subject to enhancement or other modification between capture and output, for example, to extrapolate values for pixels degraded by sensor defects. Image frames on film are subject to the chemical and physical effects of processing. Image frames are generally stored in a non-realistic form, such as a film negative or a particular type of digital image file that requires modification to render the images viewable. Digital image frames must be displayed or printed and may require other modification, such as decryption or modification for a particular display device.

The image frame include “data frames” and “non-data frames”. The data frames are images of specific indicia that are readable by an expected photofinishing system. Other image frames are non-data frames. Generally, non-data frames are user-picture frames, which are images captured by a user of a camera for the purpose of obtaining a printed final image or a final image in some other form. The user is generally, but not always the end user. Other types of non-data frames are possible. For example, some high-end cameras optically write one or more image frames with image capture information, prior to film removal.

The term “photofinish” is used herein to refer to one or more physical, chemical, optical, and digital techniques used to produce a visible output, referred to here as a “final image”, which is a printed or displayed image or a digital image that is printable or displayable. Photofinishing thus includes such techniques as chemical development and digital image modification and printing. Photofinishing can be provided repeatedly for an image unit, but the repetitions may or may not repeat the same techniques. For example, an initial photofinishing of a photographic film type image unit will include chemical development. Later photofinishing of the same image unit will not. A “photofinishing system” is a device or group of locally or remotely linked devices providing a photofinishing function.

A data frame is an image frame and, thus, is printable as a hard copy image and displayable as a display image in the same manner as non-data frames. The data frame can be a photograph of a light image or, with a digital image unit, can be digitally generated. The data frame occupies space in the image unit that could otherwise be occupied by a non-data frame. The data frame is stored in the image unit and extracted from the image unit in the same manner as the non-data frames.

With film, the requirement that a data frame is or can be extracted from the image unit in the same manner as other images, localizes the data frame upon a filmstrip into the same area of the filmstrip as the images. For example, the data frame cannot be located outside or between perforations of the filmstrip. The data frame can be located on a leader or trailer, but only if that portion of the film strip can be reduced to final output, during photofinishing in the same manner as other images. With many types of film cameras each captured image is the same size, that is, all “storing” is a standard and uniform size within narrow limits. In such film camera types, a data frame is preferably the same size as an image frame. This can be varied. For example, some cameras can capture, both full and half frame images. In this case, a data frame can be either size.

In a digital image unit, a data frame is provided as a printable/displayable digital image file. The data frame in digital memory has the same size constraints as other image files. The data frame is not limited to a particular resolution, but typically the data frame is the same size as one or more of the other image files in an image unit. Storage space in the image unit can be saved, if a data frame is stored at the minimum resolution necessary for reading the data frame, within the limits of image capture of a particular camera or other capture device. A header of an image file that contains image related information, but is not itself an image; is also not a data frame. It is preferred that a digital data frame be capable of undergoing digital processing in the same manner as associated images. For example, if image frames in a digital image unit are expected to be subject to lossy compression/decompression, then the data frame is configured so as to be capable of surviving the same lossy compression/decompression without unacceptable degradation in the same manner as non-data frames.

The data frame can be captured in the same manner as other image frames. In other words, photosensitive media, such as an electronic imager or photographic film, is exposed to a light image of the data frame. The light image can be provided by a transmission or reflection print or a display of the data frame content. With digital image units, the data frame can be digitally created.

Capture of the data frame can be before, during, or after capture of non-data frames. (Capture of the data frame after capture of non-data frames, is not preferred if there is a risk that the image unit will lack adequate storage space.) The data frame can be captured by anyone in possession of the image unit at a particular time. For example, the manufacturer can capture the data frame during manufacture, a distributor or dealer can capture a data frame prior to transfer of the image unit to an end user. The end user can also capture the data frame. The data frame can also be captured as an initial part of the photofinishing process.

The data frame content can be presented to a user in a form that allows the user to capture the content and, thus, create the corresponding data frame. The size of data frame content is a function of the environment in which the data frame content is presented and the features of the camera or other capture device used to capture the data frame. (For convenience, image capture in the following is discussed in relation to cameras.) For example, data frame content can be presented on small media, such as a card, held close to a camera or on large media farther away, such as a poster or billboard that is photographed at a distance. To make capture easier, fiducials or other features can be provided, which allow the photographer to more easily align the data frame content in the viewfinder of the camera. It may be necessary to provide other features, such as adequate lighting for image capture in a dark environment.

Depending upon how a picture is taken, the data frame content can occupy all or only part of the data frame. It is preferred that the data frame content occupy most or, more preferably, all of the data frame. This prevents user-pictures that include a data frame as incidental content from being treated as data frames. The size and nature of the data frame content can be varied to meet particular size requirements in the data frame and other limitations, such as limits on close focusing by particular cameras. For example, convenient data frame content for capture by a simple point-and-shoot camera is sized to provide a light image at three to six feet that fills the viewfinder (and the image frame). An example of a fixture for the capture of data frames using a one-time-use camera is disclosed in U.S. Pat. No. 6,628,895, which is hereby incorporated herein by reference.

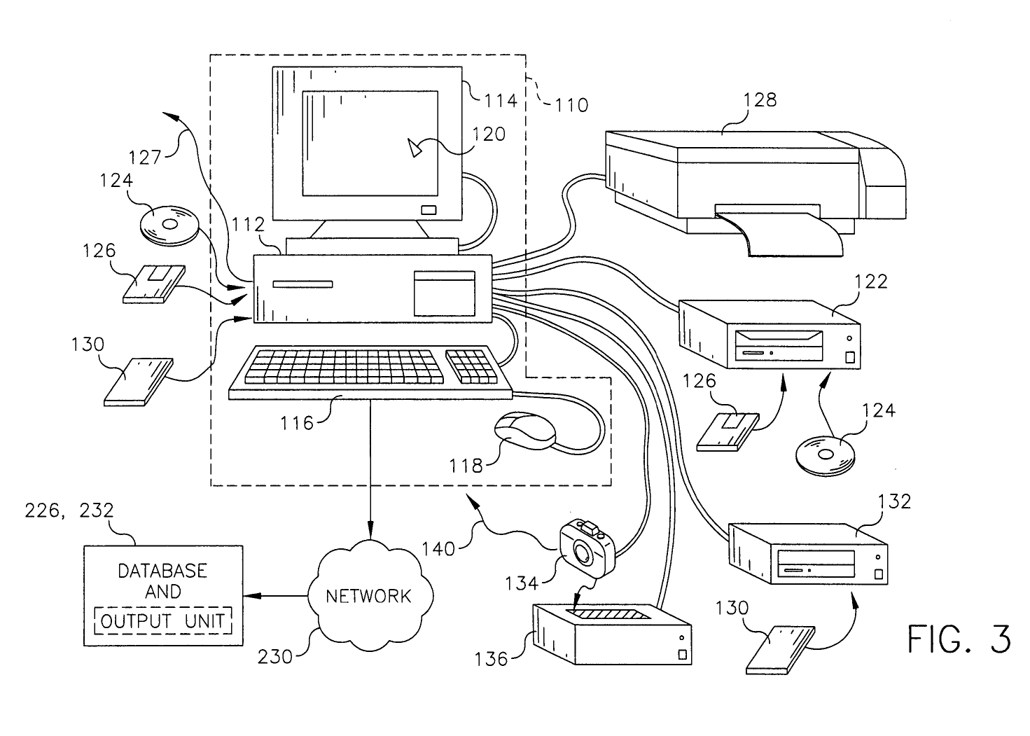

FIGS. 1 and 3 illustrate two embodiments of the system. In FIG. 1, the system includes a wholesale or retail photofinishing unit that accepts image units in the forms of both photographic film and memory units. In FIG. 3, the system includes a personal computer or the like. In both cases, the systems include a bitstream generator. An image unit is input to a bitstream generator and a bitstream is generated of the image frames in the image unit. The bitstream is sent to a controller (also referred to herein as a microprocessor based unit). The controller can include one or more programmed microprocessors and can be provided in one or more locally or remotely connected components.

The controller sends the image frames to a printer or other output device, which provides final images of all of the image frames as output. The term “final images” is used herein to refer collectively to printed images, displayed images, and displayable and printable images recorded in digital media, such as a CD-ROM or DVD.

The user is transferred a final image of the data frame in a form that allows for easy use of the access information either immediately or on a delayed basis. It is preferred that the final image be transferred to the user as hard copy, on recorded media, or in a form that is easily recordable. It is expected that the most convenient output will be as a printed image.

The non-data frames can be transferred with the data frame as separate prints or in an index print or both. The non-data frames can, alternatively, be excluded from immediate fulfillment.

The controller also sends the image frames to a database. This can be via a local or remote network, such as the Internet.

The bitstream generator includes features necessary to provide the bitstream from received image units. In FIG. 1, channel information, such as a DX code, is detected on a photographic film image unit input at an entry station. The channel information is sent to the controller. The filmstrip is chemically processed in a development unit, in accordance with the channel information. The developed filmstrip is scanned and sent to the controller. Again in FIG. 1, image frames on a digital image unit are read in a reader and sent to the controller. The reader can take a large number of different forms, many of which are shown in FIG. 3 and discussed below.

In FIG. 3, the system includes a personal computer system 110. Although the computer system 110 is shown for the purpose of illustrating a preferred embodiment, the present invention is not limited to the computer system 110 shown, but may be used on any electronic processing system such as found in digital cameras, home computers, kiosks, dock printers and other devices interacting with digital cameras and memory devices, retail or wholesale photofinishing, or any other system for the processing of digital images. The computer system 110 includes a microprocessor-based unit 112 (also referred to herein as a digital image processor) for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 may be used for moving a selector 120 on the display 114 and for selecting an item on which the selector 120 overlays, as is well known in the art.

A compact disk-read only memory (CD-ROM) 124, which typically includes software programs, is inserted into the microprocessor based unit for providing a means of inputting the software programs and other information to the microprocessor based unit 112. In addition, a floppy disk 126 may also include a software program, and is inserted into the microprocessor-based unit 112 for inputting the software program. The compact disk-read only memory (CD-ROM) 124 or the floppy disk 126 may alternatively be inserted into externally located disk drive unit 122, which is connected to the microprocessor-based unit 112. Still further, the microprocessor-based unit 112 may be programmed, as is well known in the art, for storing the software program internally. The microprocessor-based unit 112 may also have a network connection 127, such as a telephone line, to an external network, such as a local area network or the Internet. A printer 128 may also be connected to the microprocessor-based unit 112 for printing a hardcopy of the output from the computer system 110.

Images may also be displayed on the display 114 via a personal computer card (PC card) 130, such as, as it was formerly known, a PCMCIA card (based on the specifications of the Personal Computer Memory Card International Association), which contains digitized images electronically embodied in the card 130. The PC card 130 is ultimately inserted into the microprocessor based unit 112 for permitting visual display of the image on the display 114. Alternatively, the PC card 130 can be inserted into an externally located PC card reader 132 connected to the microprocessor-based unit 112. Images may also be input via the compact disk 124, the floppy disk 126, or the network connection 127. Any images stored in the PC card 130, the floppy disk 126 or the compact disk 124, or input through the network connection 127, may have been obtained from a variety of sources, such as a digital camera (not shown) or a scanner (not shown). Images may also be input directly from a digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

The output device provides a final image that has been subject to transformations. The output device can be a printer or other output device that provides a paper or other hard copy final image. The output device can also be a display output device that provides the final image as a softcopy final image. The output device can also be an output device that provides the final image as a digital file. The output device can also include combinations of output, such as a printed image and a digital file on a memory unit, such as a CD or DVD.

The present invention can be used with multiple capture devices that produce digital images. For example, FIG. 3 can represent a digital photofinishing system where the image-capture device is a conventional photographic film camera for capturing a scene on color negative or reversal film, and a film scanner device for scanning the developed image on the film and producing a digital image. The capture device can also be an electronic capture unit (not shown) having an electronic imager, such as a charge-coupled device or CMOS imager. The electronic capture unit can have an analog-to-digital converter/amplifier that receives the signal from the electronic imager, amplifies and converts the signal to digital form, and transmits the image signal to the microprocessor-based unit 112. Additionally, the same data frame can be contained in the image unit of many devices. For example, if multiple one time use cameras are used at an event, each of the film cartridges in the one time use cameras can have the same data frame, hence the same URL, and all the non-data frames from each of the cameras can be stored and accessed at the same URL. For example, if multiple digital image units are accessed at a Kiosk like a camera phone, CD and/or digital media card, a data frame is created and all non data frames from each device can be stored and accessed from a common database based on the access information stored in the data frame.

The microprocessor-based unit 112 provides the means for processing the digital images to produce pleasing looking images on the intended output device or media. The present invention can be used with a variety of output devices that can include, but are not limited to, a digital photographic printer and soft copy display. The microprocessor-based unit 112 can be used to process digital images to make adjustments for overall brightness, tone scale, image structure, etc. of digital images in a manner such that a pleasing looking image is produced by an image output device. Those skilled in the art will recognize that the present invention is not limited to just these mentioned image processing functions.

A digital image includes one or more digital image channels or color components. Each digital image channel is a two-dimensional array of pixels. Each pixel value relates to the amount of light received by the imaging capture device corresponding to the physical region of pixel. For color imaging applications, a digital image will often consist of red, green, and blue digital image channels. Motion imaging applications can be thought of as a sequence of digital images. Those skilled in the art will recognize that the present invention can be applied to, but is not limited to, a digital image channel for any of the herein-mentioned applications. Although a digital image channel is described as a two dimensional array of pixel values arranged by rows and columns, those skilled in the art will recognize that the present invention can be applied to non rectilinear arrays with equal effect. Those skilled in the art will also recognize that for digital image processing steps described hereinbelow as replacing original pixel values with processed pixel values is functionally equivalent to describing the same processing steps as generating a new digital image with the processed pixel values while retaining the original pixel values.

The general control computer shown in FIG. 3 can store implementing programs in a computer readable storage medium, which may include, for example: magnetic storage media such as a magnetic disk (such as a floppy disk) or magnetic tape; optical storage media such as an optical disc, optical tape, or machine readable bar code; solid state electronic storage devices such as random access memory (RAM), or read only memory (ROM). The associated computer program implementation may also be stored on any other physical device or medium employed to store a computer program indicated by offline memory device.

It should also be noted that the present invention can be implemented in a combination of software and/or hardware and is not limited to devices, which are physically connected and/or located within the same physical location. One or more of the devices illustrated in FIG. 3 can be located remotely and can be connected via a network. One or more of the devices can be connected wirelessly, such as by a radio-frequency link, either directly or via a network.

The present invention may be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, printed on hard-copy prints, or soft copy display), kiosks (digital or scanned input, digital processing, digital or hard copy output, or soft copy display), mobile devices (e.g., PDA or cell phone that can be used as a processing unit, a display unit, or a unit to give processing instructions), and as a service offered via the World Wide Web.

In each case, the invention may stand alone or may be a component of a larger system solution. Furthermore, human interfaces, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject the result, or may be assisted by metadata (metadata that may be user supplied, supplied by a measuring device (e.g. in a camera), or determined by an algorithm). Moreover, the algorithm(s) may interface with a variety of workflow user interface schemes.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art.

The above systems each include a database, in the form of digital memory and microprocessors and other equipment necessary to manage that digital memory and provide other functions discussed here. The database stores received non-data frames. The storage can be long term, either indefinitely or within a predetermined time limit. Alternatively, the storage can be limited to the time necessary to provide a particular fulfillment option as output via an output unit.

The database can be directly connected to the rest of the system or can be connected via a local or remote network. The database can function in a number of different ways. The database can be limited to storage of non-data frames. In that case, a user accesses the database to retrieve the images for later use in a user selected output system, such as a home personal computer, a kiosk, or a user designated wholesale lab or minilab. The database can, alternatively, provide particular output products, in addition to storage. In that case, the user can access the database to order or otherwise interact in relation to the particular output products available. For example, with a particular database, a user can order reprints or enlargements of the non-data frames in the image unit. In this case, the user does not select how the output is produced. As another alternative, the database can act as a clearinghouse for other secondary databases, which receive forwarded access requests from the user. The secondary databases can provide storage and/or output options as earlier described. This approach allows easy access for the user to obtain a multitude of fulfillment options from different sources. For example, the primary database can provide a list of fulfillment options, such as regular prints and ordinary enlargements from one source, albums from another source, and poster prints for a third source.

Fulfillment options have an almost unlimited variety, but can generally be roughly divided into three categories: remedial efforts, image alterations, and provision of additional goods and/or services. Remedial efforts are directed towards retaining the original information content, but improving the perceived quality of an image. Image alterations deliberately modify some of the original information content of an image. Table 1 lists some examples of fulfillment options, which can be provided.

TABLE 1

Optical distortion correction
Lateral color optical defect correction
Edge sharpening
Contrast correction
Color saturation correction
Improve grain, contrast, and color in underexposed pictures
Latitude improvement
Visible grain/noise reduction
Improve color accuracy/gamut remapping
Zooming and cropping
Intentional distortion
Solid color fill
Soft focus effects
Contrast exaggeration or reduction
Monochrome (black-and-white, sepia)
Redeye removal
Texture effects
Print only outlines
Add predetermined titles or logos to front or back
Solarization effects
Special borders or other photomontage
Add Copyright message
Sticker prints
Poster prints
Double prints
Selected paper surface finish
Selected digital medium
Stock photo or promotional item with order
Specific delivery, billing, or follow on services

Fulfillment options can be implemented in any manner appropriate for the particular product and/or service provided. For example, a particular fulfillment option can be provision of automatic compensation for the bluish cast seen in underwater photographs. This type of finishing is marketed by the Eastman Kodak Company of Rochester, N.Y. as Sea Processing™. Sea Processing of an image unit applies algorithms that improve the appearance of pictures captured underwater, while leaving pictures taken above water unchanged. In this case, the algorithm is automatically applied as needed. As another example, the fulfillment can be provision of a poster of a stock photo. In this case, the implementation of the fulfillment can include communication of information to an operator, who then provides a required function.

The data frames are extracted from the bitstream using an algorithm that recognizes required features of the data frame. Extraction of the access information can be based upon optical character recognition or barcode recognition or the like. Suitable techniques for this purpose are well known to those of skill in the art. Provisions can be made to help limit application of such techniques to only the data frame. For example, a data frame can be required to have particular values in one or more predefined windows of the image frame. A shape recognition algorithm can be used for detection of one or more features present in the data frames. The features can be chosen so as to render misidentification unlikely. A example of a suitable algorithm for particular features is disclosed in U.S. Pat. No. 6,741,326, which is hereby disclosed herein by reference. The data frame can also be reconstructed from the original extraction to a form that is similar to the particular output fulfillment. For example, the data frame can be scaled to better suit a particular output option or corrections can be made for processing losses.

The data frame is not limited to access information and can include indicia designating a particular fulfillment option or options (hereafter also referred to as a “subchannel”) available to the user by accessing the non-data frames stored in the database. The database can supply the non-data frames and instructions to the output unit, which can provide additional photofinishing. The output unit can be any kind of fulfillment apparatus connected or connectable to the database, including one or more of the components of the remainder of the system.

The indicia of the data frame identify a photofinishing subchannel that includes one or more fulfillment options. The indicia can be in any form that is readable by the photofinishing unit. For example, the indicia can be optically readable alphanumeric text and/or an encodement such as a two- or three-dimensional barcode. Examples of useful barcodes for this purpose and associated methods are disclosed in U.S. Pat. No. 6,456,798, to Keech et al., which is hereby incorporated herein by reference. The indicia can repeat fulfillment information in the same or different forms, such as a barcode and optically readable text. Multiple layers of encryption can be used. Encodement information can be hidden within the data frame steganographically, so as to not be visible to casual examination. Appropriate methods and apparatus for preparation and use of all of these forms of encodements are well-known to those of skill in the art. The indicia can be repeated multiple times, in the same form or different forms. In addition to the indicia, the data frame can include other functional or decorative features, for example, a decorative image can be provided, which may or may not relate to the subchannel indicated by the data frame.

The invention has been described in detail with particular reference to certain preferred embodiments thereof, but it will be understood that variations and modifications can be effected within the spirit and scope of the invention.

What is claimed is:

1. A photofinishing method comprising the steps of:
receiving an image unit having a plurality of image frames including a data frame and a plurality of non-data frames, said data frame bearing access information for a database;
outputting said data frame as a final image;
digitally transmitting said image frames to said database; and
reading said access information from said data frame in said database, following said transmitting, said reading being independent of said outputting.

2. The method of claim 1 wherein said access information is unread until said reading step.

3. The method of claim 1 wherein said outputting further comprises printing said image frames to provide printed images of said data frame and said non-data frames.

4. The method of claim 1 further comprising following said outputting and reading, maintaining said non-data frames in said database and accessible via said access information.

5. The method of claim 1 further comprising, following said reading, accepting submission of said access information to said database and providing a fulfillment product of one or more of said non-data frames responsive to said accepting, said providing being remote from said printing.

6. The method of claim 5 wherein said database is remote from said receiving and said printing.

7. The method of claim 1 wherein said data frame is the same size as one or more of said non-data frames.

8. The method of claim 1 wherein said data frame has human-readable indicia.

9. The method of claim 8 further comprising generating a photofinishing fulfillment from one or more of said non-data frames in said database, said photofinishing fulfillment being identified by said indicia, said generating being independent of said printing.

10. The method of claim 1 wherein said access information includes a uniform resource locator and a password.

11. The method of claim 1 wherein said image unit includes photographic film, said data frames and non-image frames are latent images recorded on said film, and said photofinishing further comprises:
chemically developing said latent images to provide visible images; and
scanning said visible images.

12. The method of claim 1 wherein said image unit includes digital memory and said photofinishing further comprises reading said memory.

13. A method for photofinishing an image unit having a plurality of image frames including a data frame and a plurality of non-data frames, said data frame bearing access information for a database, said method comprising the steps of:
outputting said image frames to provide final images of said data frame and said non-data frames;
transmitting said image frames to said database;
reading said access information from said data frame in said database, following said transmitting; and
retaining said access information unread until said reading step.

14. The method of claim 13 further comprising following said printing and reading, maintaining said non-data frames in said database and accessible via said access information.

15. The method of claim 13 further comprising, following said reading, accepting submission of said access information to said database and providing a fulfillment product of one or more of said non-data frames responsive to said accepting, said providing being remote from said printing.

16. The method of claim 13 wherein said printed images of said data frame and said non-data frames have a uniform size.

17. The method of claim 13 wherein said printing includes providing printed images of all of said image frames as both individual prints and in an index print.

18. A photofinishing system comprising:
a photofinishing unit receiving an image unit having a preexposed data frame including access information for a database and a plurality of non-data frames and providing a plurality of corresponding printed images and digital output, at least one of said printed images including said access information; and
a database storing said digital output, said digital output being accessible using said access information.

19. The system of claim 18 wherein said access information includes a uniform resource locator and a password.

20. The system of claim 18 further comprising a plurality of image units, each having the same said access information.
